(19) United States
(12) Patent Application Publication
(10) Pub. No.: US 2015/0083297 A1
(43) Pub. Date: Mar. 26, 2015

(54) VULCANIZATION-BONDED BODY OF THERMOPLASTIC POLYESTER RESIN MEMBER AND RUBBER MEMBER, AND METHOD FOR PRODUCING SAME

(71) Applicant: TOYO TIRE & RUBBER CO., LTD., Osaka-shi, Osaka (JP)

(72) Inventors: Shigenori Inata, Osaka-shi (JP); Toshiki Shimizu, Osaka-shi (JP); Junzo Matsuno, Osaka-shi (JP)

(73) Assignee: TOYO TIRE & RUBBER CO., LTD., Osaka-shi, Osaka (JP)

(21) Appl. No.: 14/402,912

(22) PCT Filed: Dec. 25, 2012
(86) PCT No.: PCT/JP2012/008280

§ 371 Date: Nov. 21, 2014

(30) Foreign Application Priority Data
Jun. 15, 2012 (JP) 2012-136008

(51) Int. Cl. B60C 1/00; B60C 5/00; C08J 5/12; B29D 30/06

(52) U.S. Cl. CPC B60C 1/00; B29D 30/0601; B60C 5/00; C08J 5/12; C08J 2361/12; C08J 2461/28
USPC 152/450; 264/259; 428/480

(57) ABSTRACT

In a vulcanization-bonded body of a rubber member and a resin member such as a resin film and a method for producing the vulcanization-bonded body, adhesiveness between the resin member and the rubber member is improved without adding another step. In a vulcanization-bonded body which is composed of a resin member that is formed of a thermoplastic polyester and a rubber member that is bonded to the resin member by vulcanization, the resin member contains a resorcin-based formaldehyde condensate and the rubber member contains a melamine-formaldehyde resin.

### TECHNICAL FIELD

The present invention relates to a vulcanization-bonded body of a thermoplastic polyester resin member and a rubber member that have been bonded during vulcanization molding the rubber member. The present invention further relates to a pneumatic tire equipped with such a vulcanization-bonded body in an inner liner and other parts.

### BACKGROUND ART

For example, an inner liner is provided on an inside surface of a pneumatic tire as an air permeation suppressing layer to maintain an air pressure of a tire constant. The inner liner is generally constituted of a rubber layer through which a gas is difficult to permeate, such as butyl rubber or halogenated butyl rubber. On the other hand, for the purpose of reduction in weight of a tire, use of a resin film capable of decreasing its thickness is being investigated. However, a resin member such as a resin film has a problem that adhesiveness to a rubber member is generally poor.

PTL 1 mentioned below discloses that in a laminate of a rubber layer and a polyamide resin layer, to improve adhesiveness between those layers, a resorcin-formaldehyde condensate is contained in the polyamide resin layer and an N-alkoxymethyl urea derivative is contained in the rubber layer. However, this technology is limited to the case that a resin member is a polyamide resin, and cannot be applied to a polyester resin member in which the number of reaction points is not many.

PTL 2 mentioned below proposes that in obtaining a vulcanization-bonded body comprising a rubber member such as nitrile-butadiene rubber and a resin member such as nylon, for forming a cooler hose for automobiles or the like, resorcin and a methylene donor such as hexamethylene tetramine or a formaldehyde compound are added to a rubber composition. Furthermore, PTL 3 mentioned below proposes that in a pneumatic tire containing a laminate of a film comprising a thermoplastic resin or a thermoplastic elastomer composition, and a layer of a rubber composition, a cresol-formaldehyde condensate or a modified resorcin-formaldehyde condensate, and a methylene donor such as modified etherified methylol melamine are added to the rubber composition. However, it is considered in those PTLs that adhesiveness is improved by an interaction between a reaction product between the resorcin or its derivative and the methylene donor, added to the rubber composition, and a functional group such as an amino group or a hydroxyl group in the resin member. For this reason, to achieve the improvement in adhesiveness, the resin member vulcanization-bonded to the rubber member is substantially limited to a polyamide resin. Furthermore, it is required that both the resorcin-based formaldehyde condensate and the methylene donor are added to the rubber composition. Thus, those PTLs do not teach that those are separately added.

### CITATION LIST

### Patent Literature

PTL 1: JP-A-09-239905
PTL 2: JP-A-2005-067189
PTL 3: Japanese Patent No. 4858654

### SUMMARY OF INVENTION

### Technical Problem

The present invention has been made in view of the above, and has an object to provide a vulcanization-bonded body capable of improving adhesiveness of a thermoplastic polyester resin member to a rubber member, and a method for producing the same.

### Solution to Problem

In the course of earnest investigations in view of the above problems, the present inventors have found that adhesiveness of a polyester type in which the number of reaction points is not many to a rubber member can be improved by adding a resorcin-based formaldehyde condensate to a thermoplastic polyester resin member and additionally adding a melamine-formaldehyde resin to the rubber member. The present invention is based on the finding.

Specifically, a vulcanization-bonded body according to an embodiment is a vulcanization-bonded body comprising a thermoplastic polyester resin member and a rubber member vulcanization-bonded to the resin member, wherein the resin member contains a resorcin-based formaldehyde condensate and the rubber member contains a melamine-formaldehyde resin.

A tire according to an embodiment contains the vulcanization-bonded body in an inner liner part, a sidewall part or a bead portion part.

A method for producing a vulcanization-bonded body according to an embodiment comprises a step of obtaining a thermoplastic polyester resin member containing a resorcin-based formaldehyde condensate, a step of adding a melamine-formaldehyde resin to a material constituting a rubber member and mixing those, and a step of obtaining a vulcanization-bonded body by conducting vulcanization molding in the state that the material constituting a rubber member after mixing comes into contact with the resin member.

A method for producing a pneumatic tire according to an embodiment prepares an inner liner part, a sidewall part or a bead portion part using the method for producing a vulcanization-bonded body.

### Advantageous Effects of Invention

According to the above embodiments, adhesiveness between a rubber member and a resin member can be improved by merely adding a chemical for adhesion when kneading.

### BRIEF DESCRIPTION OF DRAWING

FIG. 1 is a cross-sectional view of a pneumatic tire according to the embodiment.

### DESCRIPTION OF EMBODIMENTS

The items relating to working of the present invention are described in detail below.

The vulcanization-bonded body according to an embodiment comprises a thermoplastic polyester resin member and a rubber member vulcanization-bonded to the resin member. A resorcin-based formaldehyde condensate is added to and kneaded in the resin member before forming into a given shape such as a film. Furthermore, a melamine-formaldehyde resin is added to and kneaded in a rubber material for forming the rubber member by vulcanization molding.

It is considered that by conducting vulcanization molding in the state that the rubber material has been brought into contact with the resin member, the resorcin-based formaldehyde condensate in the resin member reacts with a methylol group of the melamine-formaldehyde resin in the rubber material, or reacts with, for example, formaldehyde supplied from the melamine-formaldehyde resin. It is considered that this forms a resorcin resin cured product at the interface between the rubber member and the resin member or its neighborhood. It is presumed that the resin cured product forms an adhesive resin layer at the interface between the rubber member and the resin member or becomes an entangled state between resin polymer chains of the resin member or rubber polymer chains of the rubber member at the interface or its neighborhood, and it is considered that this enhances adhesiveness.

Specific mechanism as to how the resorcin-based resin cured product is specifically distributed in the cross-section of a microscope scale in the vicinity of the interface and how the cured product contributes to adhesive force is not clear. However, it is considered that in the vulcanization-bonded body, the resorcin-based resin cured product is unevenly distributed to some extent in the vicinity of the interface between the vulcanized rubber member and the resin member, and at the same time the resorcin-based formaldehyde condensate remains inside the resin member and a part of the melamine-formaldehyde resin remains inside the rubber member. At least it is considered that the resorcin-based formaldehyde condensate or a component derived from the condensate is contained in the resin member in an amount larger than that in the rubber member and the melamine-formaldehyde resin or a component derived from the resin is contained in the rubber member in an amount larger than that in the resin member.

The resorcin-based formaldehyde condensate to be kneaded in the resin member is a compound obtained by condensation of phenolic compounds, at least a part of which containing resorcin, and formaldehyde, and is particularly a low molecular weight polycondensate soluble in a solvent and a resin material. The resorcin-based formaldehyde condensate has a number average molecular weight of preferably from 100 to 3,000, more preferably from 200 to 2,000, for example, from 300 to 1,000. The resorcin-based formaldehyde condensate is preferably a resol type having few branches (the form of a general phenol resin for adhesive). The resorcin-based formaldehyde condensate in which a methylol group and a dimethylene ether bond (dibenzyl ether bond) do not remain and a condensation reaction does not almost proceed by itself even though receiving heating, that is, stability is high, is preferred. For example, a percentage of a methylene bond in the total number of bonding sites between phenolic compounds can be preferably 90% or more, more preferably 95% or more, and still more preferably 97% or more. That is, it is considered that the resorcin-based formaldehyde condensate in which several phenolic compound molecules are almost linearly bonded by nearly only methylene bonds is preferred.

The resorcin-based formaldehyde condensate is that a part or the whole of the phenolic compounds bonded by a portion derived from formaldehyde is resorcin. For example, when mol content of resorcin in the phenolic compounds used is from 10 to 50% and the remainder is cresol and other alkyl phenols, the cost of raw material compounds can be reduced, and additionally, sufficient vulcanization bonding can be achieved. The resorcin-based formaldehyde condensate may be the following modified resorcin-formaldehyde resin. That is, it may be a resorcin-based formaldehyde condensate in which an unsaturated group-containing monomer is bonded to at least a part of a phenol compound constituting a skeleton to form a side chain of an aryl alkyl group (aralkyl group) or a graft-shaped polymer chain, or may be a resorcin-based formaldehyde condensate in which a polymer of an unsaturated group-containing monomer or a copolymer of the unsaturated group-containing monomer with resorcin is mixed. Furthermore, it may be a resorcin-based formaldehyde condensate partially containing an aldehyde compound other than formaldehyde. For example, it may be a reaction product obtained by coexisting at least one selected from styrene, α-methylstyrene, p-methylstyrene, α-chlorostyrene, divinylbenzene, vinylnaphthalene, indene and vinyltoluene (particularly preferably styrene) together with resorcin and formaldehyde, and may be a reaction product obtained by mixing a small amount of butyl aldehyde or other aldehyde (for example, see JP-A-08-134275, JP-T-2006-518004 (the term “JP-T” as used herein means a published Japanese translation of a PCT application), JP-T-2007-502356 and JP-T-2010-506976). The resorcin-based formaldehyde condensate basically does not contain free aldehyde at all, or does not almost contain free aldehyde, in order to constitute a methylene acceptor. Specific examples of the resorcin-based formaldehyde condensate that can be used include a resorcin-alkyl phenol-formaldehyde co-condensate (such as SUMIKANOL 620 manufactured by Sumitomo Chemical Co., Ltd.), a resorcin-formaldehyde reactant and a modified resorcin-formaldehyde resin (such as PENACOLITE resins B-18-S, B-19-S and B-19-M manufactured by INDSPEC Chemical Corporation).

The melamine-formaldehyde resin as a methylene donor to be added to a material of the rubber member is a methylolated product of melamine or its derivative, or its condensate. Specific examples include an initial condensate of a melamine resin (melamine-formaldehyde prepolymer) and materials having a form similar thereto. The melamine-formaldehyde resin has many methylol groups or dimethyl ether bonds derived therefrom, and can form a melamine resin cured product by heating the resin itself under an appropriate pH condition. Preferably, to form a melamine resin cured product, the resin has methylol groups or dimethyl ether bonds in excessive amount to a certain extent. Number average molecular weight of the melamine-formaldehyde resin is, for example, from 200 to 1,500, and as one example, from 200 to 700.

In the present application, for the sake of convenience, uncondensed methylolated melamine itself and a mixture (partial condensate) of a methylolated melamine and its condensate are also called a melamine-formaldehyde resin. The number of methylol groups in the uncondensed methylolated melamine is generally from 3 to 6. For the purpose of, for example, increasing compatibility with the rubber material, a part or the whole of methylol groups can be alkyl etherified (see JP-A-2009-126118). For example, if almost all of the methylol groups in the melamine-formaldehyde resin is methyl etherified or ethyl etherified, the resin can be easily mixed with the rubber material. Examples of the alkyl etherified methylol melamine resin include a partial condensate of hexamethylol melamine pentamethyl ether (chemical formula 1) and a partial condensate of hexamethoxymethylol melamine (chemical formula 2).

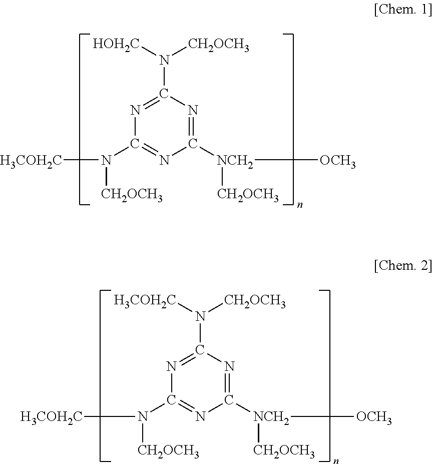

Thermoplastic polyester type is used as the resin member. That is, the resin member comprising a thermoplastic polyester resin or a thermoplastic polyester elastomer is used. Polyamide resin such as nylon has hygroscopic property because an amide group is hydrophilic, and therefore, moisture vapor transmission rate is increased. A member comprising a thermoplastic polyester elastomer is preferred as the resin member. As compared with a thermoplastic resin, the thermoplastic polyester elastomer has rubber elasticity at ordinary temperature due to the presence of a soft segment, and therefore has low Young's modulus. For this reason, moldability or durability can be enhanced by giving flexibility that follows deformation of a tire or the like. Furthermore, the thermoplastic polyester elastomer is generally excellent in air permeation resistance as compared with a thermoplastic amide elastomer, and therefore can give flexibility while maintaining air permeation resistance.

Examples of the thermoplastic polyester resin include polyethylene terephthalate (PET), polybutylene terephthalate (PBT), 1,4-cyclohexyl dimethylene terephthalate (PCT), polyethylene naphthalate (PEN), polylactic acid, other biodegradable polyester, other aliphatic polyester, aromatic polyester and its derivative. In short, it may be any thermoplastic polyester resin so long as the resin has an ester bond in a main chain. Furthermore, it may be a PET resin recovered and commercially available resins. It may be a mixture of a plurality of those.

The thermoplastic polyester elastomer may be (X) a thermoplastic polyester elastomer polymer itself comprising a block copolymer in which polyester is a hard segment, may be (Y) one comprising a continuous phase of the thermoplastic polyester elastomer polymer and a disperse phase of a rubber, and may be (Z) one comprising a continuous phase of a thermoplastic polyester resin and a disperse phase of a rubber. Of those, in the case of the embodiment (Y), a continuous phase of the resin member comprises a thermoplastic elastomer. Therefore, a resin member such as more soft film can be prepared while greatly reducing the proportion of a rubber, as compared with the embodiment (Z). Furthermore, in the case of using in an inner liner or the like, weight can be reduced by decreasing a thickness as compared with an inner liner of a rubber single body by using a thermoplastic elastomer having air permeation resistance better than that of a rubber in a continuous phase.

The thermoplastic polyester elastomer polymer (TPEE) in the embodiments (X) and (Y) is a block copolymer of a hard segment forming a thermoplastic frozen phase or crystalline phase and a soft segment showing rubber elasticity.

In the case of using in a pneumatic tire such as an inner liner, the thermoplastic polyester elastomer polymer is preferably that its melting point is from 170 to 230° C. By using a thermoplastic polyester elastomer polymer having a melting point of 170° C. or higher, particularly 180° C. or higher, a possibility that a resin member undesirably deforms is reduced when vulcanization molding a tire, and tire moldability can be secured. In the present invention, the melting point is a value measured according to DSC (differential scanning calorimeter) method of JIS K7121.

In the thermoplastic polyester elastomer polymer, polyester of the hard segment is formed by reacting dicarboxylic acid with diol. It is preferred to use an aromatic dicarboxylic acid as the dicarboxylic acid, and general aromatic dicarboxylic acid is widely used as the aromatic dicarboxylic acid. Although not particularly limited, it is preferred that main aromatic dicarboxylic acid is terephthalic acid or naphthalene dicarboxylic acid. Other acid component includes isophthalic acid. On the other hand, an aliphatic or alicyclic diol can be used as the diol. Specifically, ethylene glycol, 1,4-butanediol, 1,4-cyclohexane dimethanol and the like are exemplified.

As a component constituting polyester of the hard segment, one comprising a butylene terephthalate unit or a butylene naphthalate unit is preferred from the points of physical properties, moldability and cost performance. In the case of a naphthalate unit, 2,6-form is preferred. Aromatic polyester constituting the hard segment is not particularly limited, and, for example, one having a general number average molecular weight of from 10,000 to 40,000 can be used.

In the thermoplastic polyester elastomer polymer, examples of the constituent component of the soft segment include polyester, polyether and polycarbonate.

Examples of the polyester as the constituent component of the soft segment include aliphatic polyesters produced from aliphatic dicarboxylic acid having from 2 to 12 carbon atoms and aliphatic glycol having from 2 to 10 carbon atoms, such as polyethylene adipate, polytetramethylene adipate and poly-ε-caprolactone.

Examples of the polyether as the constituent component of the soft segment include polyalkylene ether glycols such as poly(ethylene oxide)glycol, poly(propylene oxide)glycol and poly(tetramethylene oxide)glycol, their mixtures, and copolymerized polyether glycols obtained by copolymerizing those polyether glycol constituent components.

Examples of the polycarbonate as the constituent component of the soft segment include aliphatic polycarbonate diols produced from carbonate ester such as dimethyl carbonate or diethyl carbonate, and aliphatic glycol having from 2 to 12 carbon atoms.

As the thermoplastic polyester resin in the embodiment (Z) above, the polyester constituting the hard segment of the thermoplastic polyester elastomer polymer can be used, and polyethylene terephthalate and polybutylene terephthalate are preferably used.

As the rubber constituting the disperse phase in the embodiments (Y) and (Z) above, various crosslinkable (vulcanizable) rubbers are generally used, and examples thereof include diene rubbers and their hydrogenated rubbers, such as natural rubber, epoxidized natural rubber, isoprene rubber, styrene-butadiene rubber, butadiene rubber, nitrile rubber, hydrogenated nitrile rubber and hydrogenated styrene-butadiene rubber; olefinic rubbers such as ethylene-propylene rubber, maleic acid-modified ethylene-propylene rubber, maleic acid-modified ethylene-butylene rubber, butyl rubber and acrylic rubber; halogen-containing rubbers such as halogenated butyl rubber (for example, brominated butyl rubber or chlorinated butyl rubber), chloroprene rubber or chlorosulfonated polyethylene; silicon rubbers, fluorine rubbers and polysulfide rubbers. Those may be used in any one kind alone or as mixtures of two kinds or more. Of those, it is preferred to use at least one kind selected from butyl rubber (IIR), halogenated butyl rubber such as brominated butyl rubber (Br-IIR), nitrile rubber (NBR) and hydrogenated nitrile rubber (H-NBR) from the point of air permeation resistance.

Various compounding ingredients generally added to a rubber composition, such as a filler, a softener, an age resister or a processing aid, may be added to the rubber constituting the disperse phase. That is, the rubber constituting the disperse phase may be one comprising a rubber composition comprising a rubber and various compounding ingredients added thereto.

Of (X) to (Z) above, (Y) that is a preferred embodiment is described in detail below.

Compounding ratio between the thermoplastic polyester elastomer polymer (A) and the rubber disperse phase (B) (ratio as a polymer component excluding a compounding ingredient such as a filler) is from 90/10 to 40/60, and preferably from 80/20 to 50/50, in mass ratio (A)/(B). That is, the thermoplastic polyester elastomer polymer (A) is from 90 to 40 parts by mass, and the rubber disperse phase (B) is from 10 to 60 parts by mass. Thus, by decreasing the compounding proportion of the rubber disperse phase (B) as possible, a possibility that a rubber becomes a continuous phase is decreased, and film moldability can be enhanced. Furthermore, the rubber in the rubber disperse phase (B) has large air permeation coefficient of more than 5×10¹³ fm²/Pa·s. Therefore, the air permeation coefficient of a film can be decreased by decreasing the proportion of the rubber component.

The rubber disperse phase (B) may be one which has been crosslinked in a resin member by adding a crosslinking agent, and may be uncrosslinked one. Preferably, the rubber disperse phase (B) is crosslinked during mixing a resin material or during molding on a resin member, by non-sulfur crosslinking. Particularly preferably, the rubber component constituting the rubber phase (B) dispersed in an island state contains a double bond, and crosslinkage is formed by adding a phenolic resin to a material of the resin member. That is, in the case where the rubber disperse phase (B) is that butyl rubber or halogenated butyl rubber constitutes the whole or a part of the rubber component, it is considered that a methylol group or the like reacts with a double bond originated from isoprene, thereby crosslinking occurs.

The compounding amount of the phenolic resin as a crosslinking agent is not particularly limited. For example, in the case where butyl rubber or halogenated butyl rubber occupies from 30 to 55 mass % in the polymer component of the resin member (that is, total polymer component of the thermoplastic polyester elastomer polymer (A) and the rubber (B)), the phenolic resin may be added in an amount of preferably from 0.5 to 10 parts by mass, and more preferably from 1 to 5 parts by mass, per 100 parts by mass of the polymer component. The phenolic resin here is preferably a resol type initial condensate, is, for example, a linear one or a partially branched one, and is, for example, one in which 15 or less phenol molecules have been bonded linearly by a methylene bond or a dimethylene ether bond. Phenol resin can be used as the phenolic resin. However, to enhance compatibility with a resin, a cresol resin and other alkyl phenol resin can be used. An alkyl group in the alkyl phenol resin has a straight chain or branch having, for example, from 1 to 6 carbon atoms. The phenolic resin may be a co-condensate by plural kinds of phenol compounds or a mixture of plural kinds of phenolic resins. Thus, the phenolic resin used for crosslinking the rubber phase is preferably one having many methylol groups or dimethylene ether bonds, and for example, one having from 60 to 80 dimethylene ether bonds per 100 molecules of phenols can be used (see Japanese Patent No. 4199841).

Other than the component (A) and component (B) above, a compatibilizer may be added to the thermoplastic polyester elastomer of (Y) above. The compatibilizer decreases interfacial tension between the thermoplastic polyester elastomer polymer (A) and the rubber disperse phase (B) to compatibilize those, and can enhance film moldability by decreasing particle size of a disperse phase. Examples of the compatibilizer include a polymer having one or both structures of a thermoplastic polyester elastomer polymer and a rubber, and a polymer having a functional group capable of reacting or interacting with one or both of a thermoplastic polyester elastomer polymer and a rubber. Specifically, the compatibilizer is appropriately selected depending on the kind of the thermoplastic polyester elastomer polymer and rubber used, and examples thereof include a graft copolymer in which a polycarbonate resin is a main chain and a modified acrylonitrile-styrene copolymer resin is a side chain, and a graft copolymer in which ethylene glycidyl methacrylate is a main chain and a polystyrene resin is a side chain. The compounding amount of the compatibilizer is not particularly limited, but can be from 0.5 to 10 parts by mass per 100 parts by mass of the polymer component of the resin member. Furthermore, various additives may be added within a range that does not impair the advantage of the present invention.

The material constituting the rubber member can be various rubber compositions to be vulcanization molded, and is not particularly limited. In the rubber composition, various vulcanizable rubbers are used as the rubber component (polymer component exhibiting rubber elasticity by vulcanization), and the above-described rubber constituting a disperse phase is exemplified. Preferably, it is a diene rubber such as natural rubber (NR), isoprene rubber (IR), butadiene rubber (BR), styrene-butadiene rubber (SBR), nitrile rubber (NBR) and chloroprene rubber (CR), and those can be used in one kind alone or as mixtures of two kinds or more. Particularly, in the case of using in tire, it is preferred to use NR, IR, BR, SBR or a blend rubber of two kinds or more of those.

Various additives generally used in a rubber composition, such as a filler (carbon black, silica or the like), a silane coupling agent, an oil, zinc white, stearic acid, an age resister, a wax, a vulcanizing agent or a vulcanization accelerator can be added to the rubber composition. The compounding amount of the filler is not particularly limited, but can be, for example, from 10 to 200 parts by mass per 100 parts by mass of the rubber component. More preferably, the amount is from 20 to 100 parts by mass. The vulcanizing agent includes sulfur and a sulfur-containing compound, and the compounding amount thereof is preferably from 0.1 to 10 parts by mass, and more preferably 0.5 to 5 parts by mass, per 100 parts by mass of the rubber component. The vulcanization accelerator can be at least one kind of various vulcanization accelerators of sulfenamide type, thiuram type, thiazole type, guanidine type, and the like, and the compounding amount thereof is preferably from 0.1 to 7 parts by mass, and more preferably 0.5 to 5 parts by mass, per 100 parts by mass of the rubber component.

The amount of the resorcin-based formaldehyde condensate added to the resin member is not particularly limited, but is preferably from 1 to 10 parts by mass, more preferably from 1.5 to 5 parts by mass, and still more preferably from 2 to 4 parts by mass, per 100 parts by mass of the polymer component constituting the resin member. The polymer component here is a total amount of the thermoplastic polyester resin, thermoplastic polyester elastomer polymer and rubber polymer, contained in the resin member. For example, in the case of the embodiment (Y) above, it is a total amount of the thermoplastic polyester elastomer polymer (A) and the rubber polymer constituting the rubber phase (B). The amount of the melamine-formaldehyde resin added to a material constituting the rubber member is not particularly limited, but is preferably 0.3 to 8 parts by mass, more preferably from 0.5 to 5 parts by mass, and still more preferably 0.7 to 3 parts by mass, per 100 parts by mass of the rubber component in the rubber member. The addition amount of the melamine-formaldehyde resin here is an addition amount of a net portion excluding inorganic powder and the like (“active component”). The effect for enhancing adhesiveness between the resin member and the rubber member can be increased by setting the addition amounts of the resorcin-based formaldehyde condensate and the melamine-formaldehyde resin as above. Where the addition amount of either of the resorcin-based formaldehyde condensate and the melamine-formaldehyde resin is too large, the proportion of a resorcin type resin cured product is increased, and as a result, there is a concern that flexibility as a whole is decreased.

The resin member includes a resin film, and members having various shapes such as a sheet shape and a plate shape, and is not particularly limited. Regarding a resin film that is one preferable embodiment, the term “film” encompasses not only a material having small thickness generally called a film (for example, 0.01 mm or more and less than 0.2 mm), but a material having large thickness generally called a sheet (for example, from 0.2 to 5 mm, and typically from 0.2 to 0.5 mm) Thickness of the resin is preferably from 0.02 to 1.0 mm, more preferably from 0.05 to 0.5 mm, and still more preferably from 0.3 mm or less.

In the case where the resin film is used in, for example, an inner liner of a pneumatic tire, it is preferred that an air permeation coefficient at 80° C. is 5×10¹³ fm²/Pa·s or less. Where the air permeation coefficient of the film is larger than this, superiority to the conventional general inner liner comprising a rubber composition alone having halogenated butyl rubber contained therein is decreased, and it is difficult to reduce a weight. The air permeation coefficient is more preferably 4×10¹³ fm²/Pa·s or less. The lower limit of the air permeation coefficient is not particularly limited, but is actually 0.5×10¹³ fm²/Pa·s or more. The air permeation coefficient of a film generally tends to be decreased as the proportion of the thermoplastic polyester elastomer polymer is increased and its air permeation coefficient and the air permeation coefficient of a rubber are decreased. The air permeation coefficient can be set to fall within the above range by appropriately setting those. The air permeation coefficient here is a value measured under the conditions of test gas: air and test temperature: 80° C. according to JIS K7126-1 “Plastic-Film and Sheeting-Determination of gas-Transmission rate-Part 1: Differential pressure method”. The reason that the measurement temperature is 80° C. is that in a heavy load tire used in trucks, buses and the like, because a temperature inside a tire is sometimes increased to 80° C. during running, evaluation is conducted under more severe test conditions.

In the case where the resin film is used in, for example, an inner liner of a pneumatic tire, it is preferred that Young's modulus is 150 MPa or less, and particularly 120 MPa or less. By this, follow-up property is increased, and processability when molding a tire is improved. The Young's modulus is preferably 100 MPa or less. The lower limit of the Young's modulus is not particularly limited, but is actually 5 MPa or more, and furthermore 10 MPa or more. Young's modulus of a resin film generally tends to be decreased as the proportion of the thermoplastic polyester elastomer polymer is decreased and its Young's modulus is decreased. Furthermore, Young's modulus of a resin film tends to be decreased as a particle size of a rubber that is a disperse phase is decreased. For this reason, the Young's modulus of the resin film can be set to fall within the above range by appropriately setting those.

The rubber member is bonded (that is, vulcanization bonded) to the resin member when vulcanization molding, and its shape is not particularly limited so long as it has a bonding interface to the resin member. The rubber member is not limited to an independent member, and may be, for example, a surface rubber layer attached on a surface of other unvulcanized rubber member in an unvulcanized state. For example, it may be a tie rubber layer arranged between an inner liner and a carcass ply. Furthermore, in the case where a plurality of rubber layers are integrally provided, a surface rubber layer contacting the resin member is used as the rubber member, and a melamine-formaldehyde resin may be added to only the surface rubber layer. In the case where a layer contacting the rein member is separately formed form other member and is combined with the other member in an unvulcanized state, the layer contacting the resin member can be considered as a rubber member.

A method for producing a vulcanization-bonded body comprising the resin member and rubber member described above is described below.

First of all, in the production of the resin member, a resorcin-based formaldehyde condensate is added to a thermoplastic polyester resin or elastomer, followed by melt mixing, and the resulting molten mixture is molded into a given shape according to the conventional method. For example, in the case of the resin member of (Y) above as a preferred embodiment, it can be produced as follows.

The thermoplastic polyester elastomer polymer of the component (A) and the rubber of the component (B) are melt kneaded to disperse the rubber in the thermoplastic polyester elastomer polymer forming a continuous phase, and molding the resulting mixture into a given shape using an extruder or the like. In this case, a crosslinking agent such as a phenolic resin is added to the rubber, and the rubber may be dynamically crosslinked By the dynamic crosslinking, a particle size of a disperse phase is decreased, thereby flexibility can be improved. Various compounding ingredients to the thermoplastic polyester elastomer polymer and rubber may be added during kneading, but it is preferred that those are previously added before kneading. A kneading machine used for kneading is not particularly limited, and includes a twin screw extruder, a screw extruder, a kneader and Banbury mixer.

In more detail, for example, a compounding ingredient such as a crosslinking agent is added to a rubber of the component (B) in a twin screw extruder, followed by kneading, thereby preparing pellets of a rubber masterbatch, the pellets are placed in a twin screw extruder together with a thermoplastic polyester elastomer polymer of the component (A), followed by melt kneading and dynamically crosslinking. Thus, pellets comprising a polymer composition in which the component (A) is a continuous phase and the component (B) is a disperse phase are obtained. Alternatively, a thermoplastic polyester elastomer polymer of the component (A), a rubber of the component (B) and a compounding ingredient such as a crosslinking agent are placed in a twin screw extruder, and those are melt kneaded and dynamically crosslinked. Thus, pellets comprising the polymer composition similar to the above are obtained. A method for film-forming the polymer composition thus obtained can be a general method for film-forming a thermoplastic resin or a thermoplastic elastomer, such as extrusion molding or calender molding. For example, an air permeation-resistant film is obtained by extrusion molding the pellets obtained above using a twin screw extruder or a single screw extruder. In the case of molding a resin member other than a resin film, a general method for molding a thermoplastic resin or a thermoplastic elastomer can be used.

In producing the resin member as above, the resin member is obtained by dispersing the rubber as a disperse phase in the thermoplastic polyester elastomer polymer, adding the resorcin-based formaldehyde condensate, followed by kneading, and molding the kneaded material. In this case, the resorcin-based formaldehyde condensate may be added simultaneously with, before or after the addition of the rubber material as a disperse phase. Preferably, the thermoplastic polyester elastomer polymer (A) and a material of the rubber phase (B) are mixed, and the resorcin-based formaldehyde condensate is then added. Particularly, in the case of adding a phenolic resin as a crosslinking agent as above, it is preferred that the resorcin-based formaldehyde resin is finally added. However, the order and pattern of the addition of compounding materials are not limited, and all of the compounding materials can be charged at one time and kneaded in place of conducting kneading in two stages as above.

In the method for producing a vulcanization-bonded body, a material forming the rubber member, that is, a rubber composition, is prepared. In this case, the rubber composition is obtained by adding the melamine-formaldehyde resin to the rubber composition and mixing those. The rubber composition can be prepared by kneading according to the conventional method using a mixing machine generally used, such as Banbury mixer, a kneader or a roll. The melamine-formaldehyde resin decomposes under high temperature condition to release formaldehyde. Therefore, in mixing a material of the rubber member, it is preferred to conduct kneading at, for example, 110° C. or lower, and it is more preferred to conduct kneading at 100° or lower.

The vulcanization-bonded body is obtained by conducting vulcanization molding using the rubber composition obtained as a material constituting the rubber member in the state that the material is brought into contact with the resin member. A method of vulcanization molding is not particularly limited. For example, the resin member and the material (that is, unvulcanized rubber member) are formed into a given shape such that those come into contact with each other to form a composite, and the composite may be vulcanization molded in a mold, or the composite may be vulcanization molded by press processing. Alternatively, the resin member is set in a mold for injection molding, the material is poured into the mold for injection molding, and may be integrally vulcanization molded with the resin member. Vulcanization temperature is not particularly limited, and can be, for example, from 140 to 200° C. The temperature is set to a temperature lower than a melting point of the thermoplastic polyester resin or elastomer polymer constituting the resin member.

Use of the vulcanization-bonded body thus obtained is not particularly limited. It can be preferably used in various uses requiring air permeation resistance and flexibility. The uses include various tires of automobiles, two-wheel vehicles (including bicycles), and the like, air suspension (air spring), and hoses. Preferably, it is used in a pneumatic tire, and a pneumatic tire is described below as an example.

The pneumatic tire according to an embodiment is that the vulcanization-bonded body is contained in any of sites. For example, a resin film as the resin member is vulcanization-bonded as an inner liner to an inner surface of the rubber member constituting a tire. The resin film can be preferably used in sites other than an inner liner. For example, a thickness can be reduced by laminating the resin film with a layer of the rubber member constituting a sidewall, making it possible to reduce a weight. Furthermore, it can be used as a resin member other than a resin film, and, for example, it can be used as a relatively hard member constituting a bead filler or a bead core.

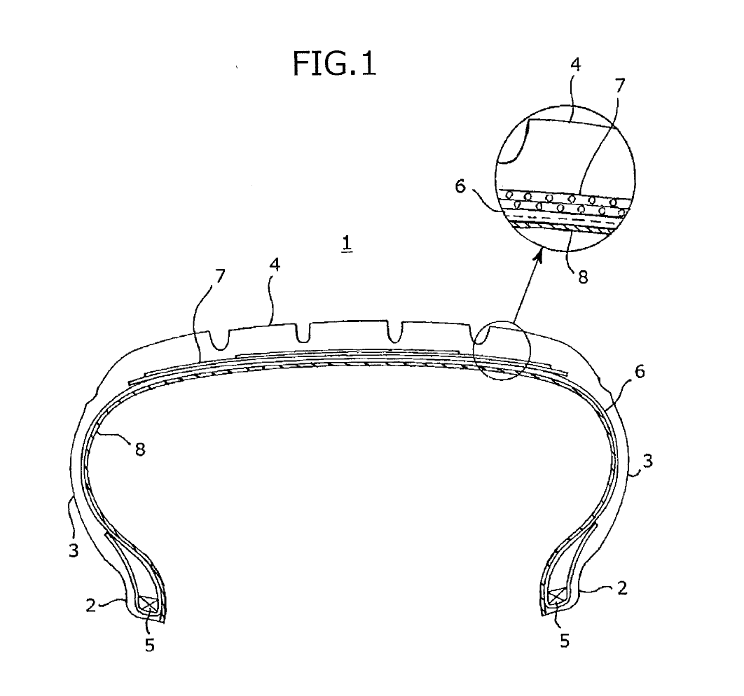

FIG. 1 is a cross-sectional view of a pneumatic tire (1) according to one embodiment. As shown in the drawing, the pneumatic tire (1) is constituted of a pair of bead parts (2) to be rimmed, a pair of sidewall parts (3) extending outwardly in a tire radial direction from the bead parts (2), and the tread part (4) grounding to a road surface, provided between the pair of sidewall parts (3). A ring-shaped bead core (5) is embedded in the pair of bead parts (2). A carcass ply (6) using an organic fiber cord is folded around the bead core (5) and locked, and is further provided by bridging between the right and left bead parts (2). A belt (7) comprising two crossing belt plies using a rigid tire cord such as a steel cord or aramide fibers is provided at an outer peripheral side in the tread part (4) of the carcass ply (6).

An inner liner (8) is provided at an inner side of the carcass ply (6) over the entire inner surface of a tire. In the present embodiment, the resin film is used as the inner liner (8). As shown in an enlarged view in FIG. 1, the inner liner (8) is attached to an inner surface of the carcass ply (6) that is a rubber layer at an inner surface side of a tire. In more detail, it is attached to an inner surface of a topping rubber layer covering a cord of the carcass ply (6).

As a method for producing such a pneumatic tire, for example, a resin film is attached to a tire molding drum, a carcass ply is attached thereto, each member such as a belt, a tread rubber or a sidewall rubber is further layered thereon to prepare a green tire, and the green tire is then vulcanization molded in a mold. Thus, a pneumatic tire is obtained.

The resin film as an inner liner can be directly vulcanization-bonded to a carcass ply as above, but can be indirectly vulcanization-bonded through a tie rubber layer. In the case of conducting vulcanization bonding through a tie rubber layer, the melamine-formaldehyde resin is added to the tie rubber layer. Furthermore, in the case of directly conducting vulcanization bonding, the formaldehyde resin can be kneaded into a topping rubber layer of the carcass ply.

In the example shown in FIG. 1, the resin film is provided at an inner surface side of the carcass layer. However, the resin film can be provided at various positions such as an outer surface side of the carcass layer so long as it is an embodiment capable of preventing permeation of air from the inside of a tire and maintaining an air pressure of tire, and the position is not particularly limited.

As the case may be, contamination resistance, a desired degree of rigidity and the like can be given by using the resin film in a sidewall part or a bead part. In the case of using in the sidewall part, for example, in forming a vulcanization-bonded body comprising a resin sheet at an outer surface side and a vulcanized rubber at an inner inside thereof, if the constitution of the present invention is employed, it is possible to reduce a weight or to give contamination resistance or the like by the resin sheet. In this case, because the resin sheet is strongly bonded to the inner vulcanized rubber layer, a problem such as peeling does not occur even though repeatedly receiving deformation. On the other hand, in the case of using in the bead part, for example, in forming a vulcanization-bonded body comprising a resin member constituting a core together with a metal material, and a vulcanized rubber surrounding the core, if the constitution of the present invention is employed, it is possible to appropriately adjust properties such as rigidity required in a bead and to give the properties. In this case, because strongly bonded, a problem such as peeling does not occur even though repeatedly receiving deformation.

As described above, according to the present embodiment, sufficient bonding between the resin member and the rubber member can be achieved by merely adding a chemical for bonding when kneading each material of the resin member and the rubber member. As a result, bonding property can be enhanced without previously conducting a surface treatment by an adhesive liquid or the like to the resin film and other resin member, that is, without adding a step.

Flexibility can be easily given to a film and the like by using a thermoplastic polyester elastomer in the resin member. As a result, tire moldability when used as, for example, an inner liner can be improved while maintaining good moldability as a film or the like. Furthermore, when the resin member has a constitution comprising a continuous phase of a thermoplastic polyester elastomer polymer and a disperse phase of a rubber, excellent air permeation resistance can be given to a film or the like as compared with a rubber single body by air permeation resistance of the thermoplastic polyester elastomer polymer constituting a continuous phase. As a result, when used as an inner liner, inner pressure holding effect of a tire can be exhibited while attempting reduction in weight by reducing thickness.

### EXAMPLES

The present invention is specifically described below based on examples, but it should be understood that the present invention is not limited to those examples.

[Evaluation of Adhesiveness and the Like]

Evaluation methods of the following adhesiveness and the like are as follows. The evaluation results are shown at the foot of Table 1 and in Table 3.

Adhesiveness: Each sample of a resin film having a thickness of 0.2 mm (resin film in Table 1) was superposed on a topping rubber layer of a carcass ply and a tie rubber layer having a thickness of 0.3 mm (rubber member in Table 1) attached to the surface of the topping rubber layer, and press vulcanization was carried out under the conditions of press temperature: 160° C., press time: 20 minutes and press pressure: 30 kg/cm² to integrally bond. The laminate obtained was cut into a strip form having a width of 10 mm and a length of 16 cm, and 180° peeling test was carried out in a peeling rate of 50 mm/min, and adhesive force was measured. The case that a material did not withstand peel force and was broken was indicated as “◯” for the reason that adhesiveness between the resin film and the rubber layer is good, and the case that interfacial peeling occurred was indicated as “x” for the reason that adhesiveness is poor. Regarding the adhesive force, the measurement values were graded according to Table 2, and the results obtained are shown at the foot of Table 1.

Young's modulus: Young's modulus was measured according to JIS K6251 “Tensile test method of vulcanized rubber”. A film prepared by extrusion molding was punched out with JIS #3 dumbbell such that a direction parallel to a flow of a resin when extruding is a tensile direction to obtain a sample, a stress-strain curve was obtained using “AUTOGRAPH AG-X” manufactured by Shimadzu Corporation, and Young's modulus was obtained from an inclination of a tangent line to the curve in its initial strain region.

Air permeation coefficient: Regarding a film prepared by extrusion molding, its air permeation coefficient was measured under the conditions of test gas: air and test temperature: 80° C. using a gas permeability measuring apparatus “BT-3” manufactured by Toyo Seiki Seisaku-Sho, Ltd. according to JIS K7126-1.

[Materials Used in Resin Film and Rubber Member]

Details of materials used in resin films and rubber members in examples and comparative examples are as follows.

Thermoplastic polyester elastomer 1 (TPEE-1): “PELPRENE C2000” manufactured by Toyobo Co., Ltd. Thermoplastic polyester elastomer polymer in which a hard segment is polybutylene terephthalate (PBT) and a soft segment is aliphatic polycarbonate. Melting point: 207° C., air permeation coefficient: 2.34×10¹³ fm²/Pa·s, and Young's modulus: 213 MPa. Glycol of polycarbonate comprises 1,6-hexanediol.

Thermoplastic polyester elastomer 2 (TPEE-2): “PELPRENE P280B” manufactured by Toyobo Co., Ltd. Thermoplastic polyester elastomer polymer in which a hard segment is PBT and a soft segment is polytetramethylene glycol (PTMG). Melting point: 218° C., air permeation coefficient: 1.80×10¹³ fm²/Pa·s, and Young's modulus: 370 MPa.

Polybutylene terephthalate (PBT): “TORAYCON 1401-X31” manufactured by Toray Industries, Inc.

Butyl rubber (IIR): “EXXON BUTYL 268” manufactured by Exxon Mobil Chemical.

Nitrile rubber (NBR): “PN30A” manufactured by JSR Corporation (Powdered NBR, amount of acrylonitrile=35 wt %).

Compatibilizer-1: “BONDFAST-E” manufactured by Sumitomo Chemical Co., Ltd., a copolymer of glycidyl methacrylate (12 wt %) and ethylene (remainder).

Compatibilizer-2: “MODIPER CL430” manufactured by NOF Corporation, a graft polymer in which polycarbonate (PC) is a main chain and acrylonitrile-styrene copolymer (AS) modified with glycidyl methacrylate (GMA) is a side chain.

Phenolic resin (crosslinking agent): Alkyl phenol-formaldehyde condensate, “TACKIROL 201” manufactured by Taoka Chemical Co., Ltd. (http://www.taoka-chem.co.jp/business/pdf/additives.pdf).

Resorcin-based formaldehyde condensate (1): Modified resorcin-formaldehyde condensate, “SUMIKANOL 620” manufactured by Taoka Chemical Co., Ltd. (chemical formula 3 below; R is a hydrocarbon group. n is an integer in each molecule, but an average value includes the number after the decimal point.

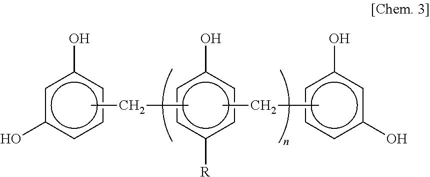

Resorcin-based formaldehyde condensate (2): Penacolite resin “B-19-S” manufactured by INDSPEC Chemical Corporation (resorcin-formaldehyde/resorcin-polymer composite resin, softening point: 107° C.).

Melamine-formaldehyde resin: Alkyl etherified methylol melamine resin, “SUMIKANOL 507AP” manufactured by Taoka Chemical Co., Ltd. (“Modified etherified methylol melamine resin”) (http://www.taoka-chem.co.jp/business/pdf/additives.pdf). Active component: 65%, ash component: 30%.

Natural rubber (NR): RSS#3

Styrene-butadiene rubber (SBR): “NIPOL 1502” manufactured by Zeon Corporation.

Carbon black: “SHOWA BLACK N-330T” manufactured by Cabot Japan.

Stearic acid: “LUNAC S-20” manufactured by Kao Corporation.

Zinc oxide: “ZINC WHITE #3” manufactured by Mitsui Mining & Smelting Co., Ltd.

Sulfur: “POWDERED SULFUR” manufactured by Tsurumi Chemical Co., Ltd.

Vulcanization accelerator: “NOCCELER NS-P” manufactured by Ouchi Shinko Chemical Industrial Co., Ltd.

[Production Method]

### Example 1

Resin film: A thermoplastic polyester elastomer (TPEE-1), butyl rubber, a phenolic resin and a compatibilizer were charged according to the formulation (parts by mass) shown in Table 1 below, and the resulting mixture was melt kneaded by a twin screw kneading machine (manufactured by PLABOR Research Laboratory of Plastic Technology Co., Ltd.), thereby dynamically crosslinking and palletizing. A resorcin-based formaldehyde condensate was added to the dynamically crosslinked product obtained, and the resulting mixture was melt kneaded using a twin screw kneading machine to obtain pellets. The pellets obtained were T-die molded into a film having a width of 350 mm and a thickness of 0.2 mm by a single screw extruder. The resin film obtained was a film comprising a thermoplastic polyester elastomer in which TPEE-1 is a continuous phase and butyl rubber is a disperse phase.

Unvulcanized rubber member: Materials for forming a tie rubber layer to be attached on the surface of a topping rubber layer of a carcass ply were kneaded according to the formulation (parts by mass) shown in Table 1 below to obtain a kneaded product. In this case, each material excluding vulcanization chemicals (sulfur and vulcanization accelerator) and a melamine-formaldehyde resin was sufficiently mixed in Banbury mixer, vulcanization chemical and a melamine-formaldehyde resin were then added while gradually conducting the mixing such that a temperature of an inside rubber material was maintained at 100° C. or lower, and the kneading was continued for a while. The kneaded material was taken out, and molded into a sheet shape by cold rollers. The sheet was cut into a given size, and attached to an unvulcanized topping rubber layer.

Vulcanization molding and vulcanization bonding: As described in the item of the adhesiveness evaluation described above.

### Example 2

The resorcin-formaldehyde resin was not added to the rubber member, and other than this, Example 1 was followed.

### Examples 3 to 5 and 7

The formulation of the resin film was changed as shown in Table 1, and other than this, Example 2 was followed.

### Example 6

A resorcin-based formaldehyde condensate was added to a thermoplastic polyester elastomer (TPEE-1) according to the formulation (parts by mass) shown in Table 1, and the resulting mixture was melt kneaded using a twin screw kneading machine to obtain pellets. The pellets obtained were T-die molded into a film having a width of 350 mm and a thickness of 0.2 mm by a single screw extruder. Other than the above, Example 2 was followed.

### Example 8

Polybutylene terephthalate (PBT), butyl rubber, a phenolic resin and a compatibilizer were charged according to the formulation (parts by mass) shown in Table 1, and the resulting mixture was melt kneaded by a twin screw kneading machine, thereby dynamically crosslinking and palletizing. A resorcin-based formaldehyde condensate was added to the dynamically crosslinked material obtained, and the resulting mixture was melt kneaded using a twin screw kneading machine to obtain pellets. The pellets obtained were T-die molded into a film having a width of 350 mm and a thickness of 0.2 mm by a single screw extruder. The resin film obtained was a film comprising a thermoplastic polyester elastomer in which PBT is a continuous phase and butyl rubber is a disperse phase. Other than the above, Example 2 was followed.

### Comparative Examples 1 to 3

In Comparative Example 1, the resorcin-based formaldehyde condensate and the melamine-formaldehyde resin were not added to either of the resin film and a material of the rubber member, and other than this, Example 1 was followed.

In Comparative Example 2, the resorcin-based formaldehyde resin was not added to the resin film, and other than this, Example 1 was followed. That is, in Comparative Example 2, the resorcin-based formaldehyde condensate and the melamine-formaldehyde resin were added to a material of the rubber member and were not added to the resin film.

In Comparative Example 3, the resorcin-based formaldehyde condensate and the melamine-formaldehyde resin were added to the resin film and were not added to a material of the rubber member, and other than this, Example 1 was followed.

TABLE 1

| | | Compar- | Compar- | Compar- | | | | | | | | |
|---|---|---|---|---|---|---|---|---|---|---|---|---|
| | | ative | ative | ative | Exam- | Exam- | Exam- | Exam- | Exam- | Exam- | Exam- | Exam- |
| | | Example 1 | Example 2 | Example 3 | ple 1 | ple 2 | ple 3 | ple 4 | ple 5 | ple 6 | ple 7 | ple 8 |
| Resin film | TPEE-1 (C2000) | 50 | 50 | 50 | 50 | 50 | 80 | 60 | | 100 | 50 | |
| Formulation | TPEE-2 (P-280B) | | | | | | | | 50 | | | |
| (parts by | PBT | | | | | | | | | | | 50 |
| mass) | IIR | 50 | 50 | 50 | 50 | 50 | 20 | | 50 | | 50 | 50 |
| | NBR | | | | | | | 40 | | | | |
| | Compatibilizer-1 | 5 | 5 | 5 | 5 | 5 | 8 | | 5 | | 5 | 5 |
| | Compatibilizer-2 | | | | | | | 6 | | | | |
| | Phenolic resin | 2.5 | 2.5 | 2.5 | 2.5 | 2.5 | 1 | 0.4 | 2.5 | | 2.5 | 2.5 |
| | Resorcin-based | | | 2.5 | 2.5 | 2.5 | 2.5 | 2.5 | 2.5 | 2.5 | | |
| | formaldehyde | | | | | | | | | | | |
| | condensate (1) | | | | | | | | | | | |
| | Resorcin-based | | | | | | | | | | 2.5 | 2.5 |
| | formaldehyde | | | | | | | | | | | |
| | condensate (2) | | | | | | | | | | | |
| | Melamine-form- | | | 2.5 | | | | | | | | |
| | aldehyde resin | | | | | | | | | | | |
| Rubber | NR | 80 | 80 | 80 | 80 | 80 | 80 | 80 | 80 | 80 | 80 | 80 |
| member | SBR | 20 | 20 | 20 | 20 | 20 | 20 | 20 | 20 | 20 | 20 | 20 |
| Formulation | Carbon black | 50 | 50 | 50 | 50 | 50 | 50 | 50 | 50 | 50 | 50 | 50 |
| (parts by | Stearic acid | 2 | 2 | 2 | 2 | 2 | 2 | 2 | 2 | 2 | 2 | 2 |
| mass) | Zinc oxide | 3 | 3 | 3 | 3 | 3 | 3 | 3 | 3 | 3 | 3 | 3 |
| | Sulfur | 3 | 3 | 3 | 3 | 3 | 3 | 3 | 3 | 3 | 3 | 3 |
| | Vulcanization | 1 | 1 | 1 | 1 | 1 | 1 | 1 | 1 | 1 | 1 | 1 |
| | accelerator | | | | | | | | | | | |
| | Resorcin-based | | 1.5 | | 1.5 | | | | | | | |
| | formaldehyde | | | | | | | | | | | |
| | condensate (1) | | | | | | | | | | | |
| | Melamine-form- | | 1.5 | | 1.5 | 1.5 | 1.5 | 1.5 | 1.5 | 1.5 | 1.5 | 1.5 |
| | aldehyde resin | | | | | | | | | | | |

| | | | | | | | | | | | |
|---|---|---|---|---|---|---|---|---|---|---|---|
| Adhesiveness | x | x | x | ∘ | ∘ | ∘ | ∘ | ∘ | ∘ | ∘ | ∘ |
| Grade of adhesive force | 0 | 0 | 0 | 4 | 4 | 1 | 1 | 4 | 1 | 3 | 3 |

TABLE 2

| Adhesive force (N/mm) | Grade of adhesive force |
|---|---|
| 0 to less than 1 (N/mm) | 0 |
| 1 to less than 2 (N/mm) | 1 |
| 2 to less than 3 (N/mm) | 2 |
| 3 to less than 4 (N/mm) | 3 |
| 4 or more (N/mm) | 4 |

TABLE 3

| | Examples 1 and 2 | Example 5 |
|---|---|---|
| Young's modulus (MPa) | 40 | 56 |
| Air permeation coefficient | 4.65 | 3.93 |
| (×10¹³ fm²/Pa · s) | | |

[Evaluation]

As shown in Table 1, excellent adhesiveness was obtained in Examples 1 and 2 by adding an appropriate amount of the resorcin-based formaldehyde condensate to the resin film and additionally adding an appropriate amount of the melamine-formaldehyde resin to a material of the rubber member. When the resorcin-based formaldehyde condensate was further added to a material of the rubber member as in Example 1, it was considered that the adhesiveness was equal to or was slightly lower than that of Example 2 in which the resorcin-based formaldehyde condensate was not added. In other words, it was considered that there is no particular significance to add the resorcin-formaldehyde condensate to a material of the rubber member. Furthermore, as shown in Table 3, the resin films of Examples 1 and 2 were excellent in Young's modulus and air permeation coefficient.

On the other hand, in Comparative Example 1 in which the resorcin-based formaldehyde condensate and the melamine-formaldehyde resin were not added to either of the resin film and a material of the rubber member under the same conditions as in Examples 1 and 2, peel adhesive force obtained was very low value as 4% or less of the cases of Examples 1 and 2. Furthermore, in Comparative Example 2 in which the resorcin-based formaldehyde condensate and the melamine-formaldehyde resin were added to only a material of the rubber member and Comparative Example 3 in which those were added to only the resin film, the adhesive force was slightly improved as compared with Comparative Example 1. Considering those results together with the results of Examples 1 and 2, it is understood that for the improvement in adhesiveness, the resorcin-based formaldehyde condensate is required to be added to the resin film and the melamine-formaldehyde resin is required to be added to a material of the rubber member.

In Example 3, the mixing weight ratio between the thermoplastic polyester elastomer (TPEE-1) and the butyl rubber was set to 80:20, and due to this, the mixing amount of the phenolic compound was reduced. As a result, good adhesiveness was obtained, but adhesive force was lower as compared with that of Examples 1 and 2. This suggests that when the proportion of the rubber phase in the resin film is low, adhesive force is decreased.

On the other hand, in Example 4, in preparing the resin film, nitrile rubber was used in place of butyl rubber (IIR), and the mixing weight ratio between the thermoplastic polyester elastomer (TPEE-1) and the rubber was set to 60:40. As a result, adhesive force was slightly decreased as compared with Example 3, but good peel adhesiveness was obtained.

In Example 5, Example 2 was followed, except that the thermoplastic polyester elastomer (TPEE-2) in which a soft segment is polytetramethylene glycol (PTMG) was used in place of the thermoplastic polyester elastomer in which the soft segment is aliphatic polycarbonate. As a result, good peel adhesiveness equal to Examples 1 and 2 was obtained. In Example 6 in which the resin film does not contain the rubber phase, sufficient adhesion was obtained, but the adhesion was slightly lower than Example 3 in which the rubber content in the resin film was small. This shows that the rubber phase in the resin film is not essential, but is better to be present. However, in the case of comparing with adhesive force in Example 3 in which the rubber phase content was 20 mass %, the difference was not really remarkable.

In Example 7, the resorcin-formaldehyde/resorcin-polymer composite resin was used as the resorcin-based formaldehyde condensate, and adhesive force was slightly poorer as compared with Example 2, but good peel adhesiveness was obtained.

In Example 8, polybutylene terephthalate (PBT) was used in place of the thermoplastic polyester elastomer polymer, and adhesive force was slightly decreased as compared with Example 2, but good adhesive force was shown.

### INDUSTRIAL APPLICABILITY

The present invention can be utilized in various resin-rubber composites in which adhesiveness is required between a resin member and a rubber member, and preferably can be utilized in rubber products in which air permeation resistance, contamination resistance and the like are required. Particularly, the present invention can be preferably utilized in various pneumatic tires of automobiles (passenger cars, trucks, buses and the like), two-wheel vehicles, and the like.

### REFERENCE SIGNS LIST

1 Pneumatic tire
6 Carcass ply
8 Inner liner

1. A vulcanization-bonded body comprising a thermoplastic polyester resin member and a rubber member vulcanization-bonded to the resin member,
wherein the resin member contains a resorcin-based formaldehyde condensate and the rubber member contains a melamine-formaldehyde resin.

2. The vulcanization-bonded body according to claim 1, wherein the resin member comprises a thermoplastic polyester elastomer.

3. The vulcanization-bonded body according to claim 2, wherein the resin member comprises a continuous phase of a thermoplastic polyester elastomer polymer comprising a block copolymer in which polyester is a hard segment, and a disperse phase of a rubber.

4. The vulcanization-bonded body according to claim 3, wherein the disperse phase comprises butyl rubber or halogenated butyl rubber, and the rubber of the disperse phase is crosslinked by the addition of a phenolic resin.

5. The vulcanization-bonded body according to claim 1, wherein the resorcin-based formaldehyde condensate is a resorcin-alkyl phenol-formaldehyde co-condensate or a modified resorcin-formaldehyde resin, and the melamine-formaldehyde resin is an alkyl etherified methylol melamine resin.

6. A pneumatic tire containing the vulcanization-bonded body according to claim 1 in an inner liner part, a sidewall part or a bead portion part.

7. A method for producing a vulcanization-bonded body comprising a resin member and a rubber member, the method comprising:
a step of obtaining a thermoplastic polyester resin member containing a resorcin-based formaldehyde condensate,
a step of adding a melamine-formaldehyde resin to a material constituting a rubber member and mixing those, and
a step of obtaining a vulcanization-bonded body by conducting vulcanization molding in the state that the material constituting a rubber member after mixing is brought into contact with the resin member.

8. The method for producing a vulcanization-bonded body according to claim 7, wherein the resin member is obtained by adding the resorcin-based formaldehyde condensate to the thermoplastic polyester elastomer, followed by mixing and molding.

9. The method for producing a vulcanization-bonded body according to claim 8, wherein in the step of obtaining the resin member, rubber is dispersed as a disperse phase in the thermoplastic polyester elastomer comprising a block copolymer in which polyester is a hard segment, and additionally the resorcin-based formaldehyde condensate is added, followed by mixing and molding.

10. The method for producing a vulcanization-bonded body according to claim 9, wherein the disperse phase comprises butyl rubber or halogenated butyl rubber, and a phenolic resin for crosslinking the rubber of the disperse phase is added in the step of obtaining the resin member.

11. A method for producing a pneumatic tire, comprising preparing an inner liner part, a sidewall part or a bead portion part using the method for producing a vulcanization-bonded body according to claim 7.
